(19) United States
(12) Patent Application Publication
(10) Pub. No.: US 2011/0141652 A1
(43) Pub. Date: Jun. 16, 2011

(54) MULTILAYER CERAMIC CAPACITOR

(75) Inventors: Dong Ik Chang, Suwon (KR); Hyo Jung Kim, Seoul (KR); Jong Hoon Bae, Anyang (KR); Chul Seung Lee, Seoul (KR); Doo Young Kim, Yongin (KR)

(73) Assignee: SAMSUNG ELECTRO-MECHANICS CO., LTD.

(21) Appl. No.: 12/752,640

(22) Filed: Apr. 1, 2010

(30) Foreign Application Priority Data
Dec. 15, 2009 (KR) 10-2009-0125093

(51) Int. Cl. H01G 2/14; H01G 4/12

(52) U.S. Cl. 361/272

(57) ABSTRACT

A multilayer ceramic capacitor includes: an effective layer formed by alternately laminating inner electrodes and dielectric layers; and a protection layer formed by stacking dielectric layers on upper and lower surfaces of the effective layer, wherein the thickness of the protection layer is 10.0 to 30.0 times the sum of an average thickness of the inner electrodes and an average thickness of the dielectric layers within the effective layer.

### CROSS-REFERENCE TO RELATED APPLICATIONS

This application claims the priority of Korean Patent Application No. 10-2009-0125093 filed on Dec. 15, 2009, in the Korean Intellectual Property Office, the disclosure of which is incorporated herein by reference.

### BACKGROUND OF THE INVENTION

1. Field of the Invention

The present invention relates to a multilayer ceramic capacitor and, more particularly, to a multilayer ceramic capacitor capable of preventing a crack and breakdown (i.e., dielectric break) due to a thermal impact while stably securing capacitance.

2. Description of the Related Art

In general, a multilayer ceramic capacitor includes a plurality of ceramic dielectric sheets and inner electrodes inserted between the plurality of ceramic dielectric sheets. Because the multilayer ceramic capacitor can implement a high capacitance for its small size and can be easily mounted on a substrate, it is commonly used as a capacitive component for various electronic devices.

Recently, as electronic products (i.e., home appliances, etc.) become compact and multi-functional, chip components have tended to become compact and highly functional. Following this trend, a multilayer ceramic capacitor is required to be smaller than ever before, but to have a high capacity, and at present, a multilayer ceramic capacitor having five hundred or more dielectric layers, each with a thickness of 2 um or less stacked therein, is being fabricated.

In this respect, however, because the ceramic dielectric layers are extremely thin and highly stacked, the volume ratio of inner electrode layers increases, causing a crack or breakdown (i.e., dielectric break) to the ceramic laminated body due to a thermal impact applied in the process of mounting them on a circuit board by firing, reflow soldering, and the like.

In detail, a crack is generated as stress caused by the difference of thermal expansion coefficient between a material forming the ceramic layers and a material forming the inner electrode layers acts on the ceramic laminated body, and in particular, both edges of upper and lower portions of the multilayer ceramic capacitor are mostly cracked.

In addition, stress is also generated at the uppermost and lowermost portions of the dielectric layers due to a thermal change, and in this case, when voltage is applied, a breakdown of the dielectric layers may be generated.

### SUMMARY OF THE INVENTION

An aspect of the present invention provides a multilayer ceramic capacitor capable of effectively preventing a crack and breakdown of a ceramic laminated body due to a thermal impact while stably securing capacitance.

According to an aspect of the present invention, there is provided a multilayer ceramic capacitor including: an effective layer formed by alternately laminating inner electrodes and dielectric layers; and a protection layer formed by stacking dielectric layers on upper and lower surfaces of the effective layer, wherein the thickness of the protection layer is 10.0 to 30.0 times the sum of an average thickness of the inner electrodes and an average thickness of the dielectric layers within the effective layer.

The inner electrodes may include: a plurality of continuous intervals in which a conductive material is continuously formed; and an interrupted interval filled with pores or ceramic between the neighboring continuous intervals, wherein when the total length of the inner electrodes is A and the sum of the lengths of the continuous intervals is B, the following conditional expression 1 is satisfied: [Conditional expression 1] 0.92≦B/A<1.

The thickness of each of the dielectric layers within the effective layer may be 5 um or less.

The number of stacked dielectric layers within the effective layer may be 100 or greater.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a multilayer ceramic capacitor according to an exemplary embodiment of the present invention;

FIG. 2 is a sectional view taken along line I-I′ in FIG. 1; and

FIG. 3 is a graph of changes in capacitance and breakdown voltage over connectivity of inner electrodes.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art.

The same or equivalent elements are referred to as the same reference numerals throughout the specification.

It will be understood that when an element is referred to as being “connected with” another element, it can be directly connected with the other element or may be indirectly connected with the other element with element(s) interposed therebetween. Unless explicitly described to the contrary, the word “comprise” and variations such as “comprises” or “comprising,” will be understood to imply the inclusion of stated elements but not the exclusion of any other elements.

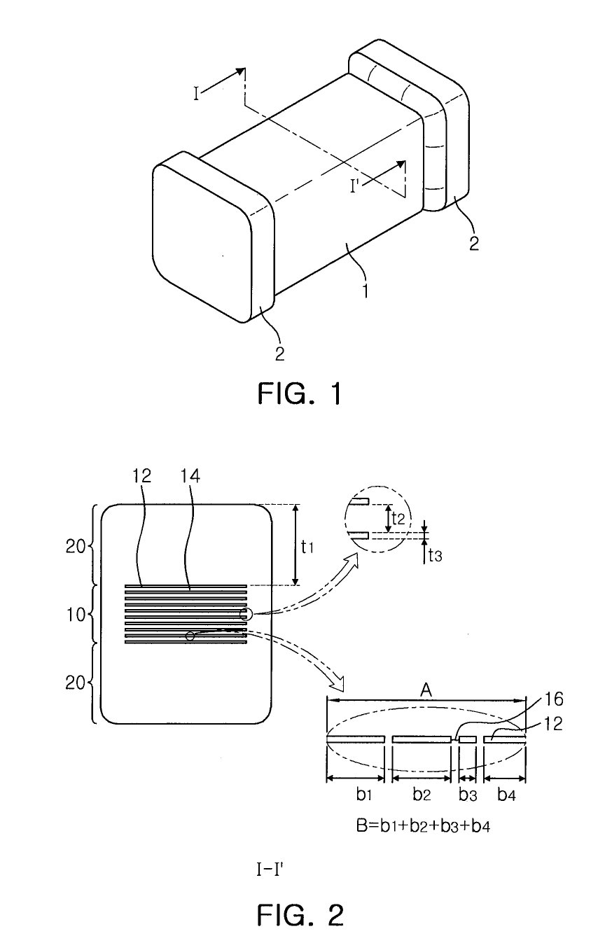

FIG. 1 is a perspective view of a multilayer ceramic capacitor according to an exemplary embodiment of the present invention.

With reference to FIG. 1, a multilayer ceramic capacitor according to an exemplary embodiment of the present invention may include a capacitor body 1 and outer electrodes 2.

The capacitor body 1 may include a plurality of dielectric layers stacked therein and inner electrodes insertedly positioned between the plurality of dielectric layers. In this case, the dielectric layers may be made of barium titanate (Ba₂TiO₃) and the inner electrodes may be made of nickel (Ni), tungsten (W), cobalt (Co), and the like.

The outer electrodes 2 may be formed on both side surfaces of the capacitor body 1. The outer electrodes 2 are formed to be electrically connected with the inner electrodes exposed from an outer surface of the capacitor body 1, serving as an external terminal. In this case, the outer electrodes 2 may be made of copper (Cu).

FIG. 2 is a sectional view taken along line I-I′ in FIG. 1.

With reference to FIG. 2, the multilayer ceramic capacitor according to an exemplary embodiment of the present invention may include an effective layer 10 formed by alternately stacking inner electrodes 12 and dielectric layers 14, and a protection layer 20 formed by stacking a plurality of dielectric layers on upper and lower surfaces of the effective layer 10.

First, the connectivity of the inner electrodes may be defined as follows.

Generally, the inner electrodes 12 formed within the multilayer ceramic capacitor are not completely connected; they have disconnected portions. The process of forming the inner electrodes 12 is performed through a printing method by using conductive paste containing a metallic powder such as a nickel (Ni) powder on one surface of a ceramic green sheet, leaving some empty spaces therein.

Thus, when the multilayer ceramic capacitor is viewed from its section in a certain direction, the inner electrodes 12 have pores 16 here and there at some portions present therein, rather than being completely connected.

When the length of the inner electrodes 12 including the pores 16 is A and the sum of the lengths of the parts of the inner electrodes, excluding the pores 16, is B with reference to FIG. 2, the connectivity of the inner electrodes may be defined as B/A.

The relationship among capacitance, a breakdown voltage, and the likelihood of the generation of a crack due to a thermal impact, according to the connectivity of the inner electrodes, is as follows.

When the connectivity of the inner electrodes is high, it means that the inner electrodes are formed with few disconnected portions, so a large capacitance can be secured as compared with the case where connectivity is low. Also, because the thickness of the dielectric layers between the inner electrodes is uniform, a breakdown voltage increases. However, due to a step generated by the difference of a thermal expansion coefficient between the material (e.g., a metallic material such as nickel (Ni)) forming the inner electrodes and the ceramic, when the inner electrodes are exposed to a thermal impact applied thereto, they are likely to crack.

Meanwhile, when the connectivity of the inner electrodes is low, the capacitance of the inner electrodes is reduced and the thickness of the dielectric layers between the inner electrodes is not uniform, causing a problem that the breakdown voltage decreases. However, a step generated due to the difference of the thermal expansion coefficient between the material forming the inner electrodes and the ceramic is lessened to help prevent a crack of the inner electrode by a potential thermal impact.

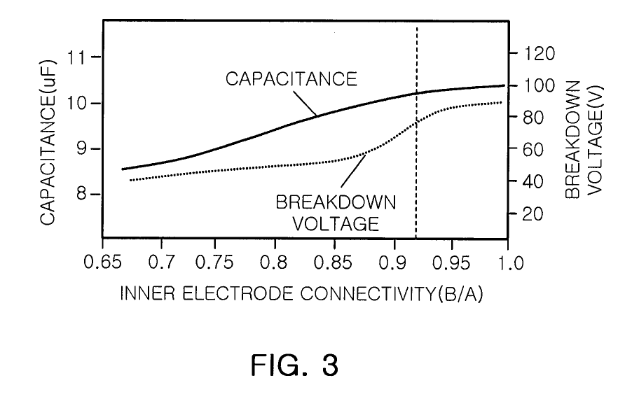

FIG. 3 is a graph of changes in capacitance and breakdown voltage over connectivity of inner electrodes.

With reference to FIG. 3, it is noted that as the connectivity of the inner electrodes increases, the capacitance and breakdown voltage increase. In particular, when the connectivity of the inner electrodes is 0.92 or greater, the capacitance and breakdown voltage are 90 percent of a maximum value or greater, thereby providing stability.

However, the formation of the inner electrodes to have such a high connectivity accompanies the problem of the generation of a crack due to a thermal impact. Thus, in order to solve the problem, in the present invention, the ratio of the sum of an average thickness (t₂) of the dielectric layers 14 and an average thickness (t₃) of the inner electrodes 12 within the effective layer to the thickness (t₁) of the protection layer 20 is adjusted.

TABLE 1

| | Connectivity | | Ratio of | Number of |
|---|---|---|---|---|
| | of inner | | thickness of | generated |
| | electrodes | Capacitance | dielectric | cracks due to |
| Embodiment | (B/A) | (uF) | layers | thermal impact |
| 1 | 0.98 | 10.2 | 40 | 11/200 |
| 2 | 0.98 | 10.2 | 35 | 7/200 |
| 3 | 0.98 | 10.2 | 32 | 2/200 |
| 4 | 0.98 | 10.3 | 29 | 0/200 |
| 5 | 0.98 | 10.3 | 15 | 0/200 |
| 6 | 0.98 | 10.3 | 10 | 0/200 |
| 7 | 0.98 | 10.3 | 8 | 5/200 |

Table 1 shows the results obtained by measuring the capacitance and the number of generated cracks caused by a thermal impact while changing the ratio (t₁/(t₂+t₃)) of the sum of an average thickness (t₂) of the dielectric layers 14 and an average thickness (t₃) of the inner electrodes 12 within the effective layer to the thickness (t₁) of the protection layer 20 in a state that the connectivity of the inner electrodes is fixed as 0.98.

In this case, the nickel (Ni) powder having the particle size of 0.1 um to 0.2 um was used as the conductive paste for forming the inner electrodes 12 and the content of the nickel powder was 40 to 50 percent. Also, for thermal impact testing, the inner electrodes were dipped in a lead pot at 320 degrees Celsius for two seconds.

With reference to Table 1, it is noted that the number of generated cracks due to the thermal impact is significantly reduced in the embodiments in which the thickness ratio (t₁/(t₂+t₃)) of the dielectric layers is 10 to 30, compared with the other embodiments.

In the embodiments of Table 1, the connectivity of the inner electrodes is all 0.98, so it is noted that a crack caused by a thermal impact can be effectively prevented by adjusting the thickness ratio (t₁/(t₂+t₃)) such that it is within 10 to 30 no matter whether the connectivity of the inner electrodes is high.

Accordingly, the multilayer ceramic capacitor according to one exemplary embodiment of the present invention is formed such that the protection layer 20 is formed to have the thickness (t₁) which is 10 to 30 times the sum of the average thickness (t₂) of the dielectric layers and the average thickness (t₃) of the inner electrodes 12 within the effective layer, thus effectively preventing the generation of a crack due to a thermal impact.

Also, the multilayer ceramic capacitor, according to another exemplary embodiment of the present invention, is formed such that the connectivity of the inner electrodes is 0.92 or greater, thus stably securing the capacitance and obtaining high breakdown voltage.

As set forth above, in the multilayer ceramic capacitor according to exemplary embodiments of the invention, because the thickness of the protection layer is 10 to 30 times the sum of an average thickness of the dielectric layers and the inner electrodes, although the inner electrodes has a high connectivity, a potential crack due to a thermal impact can be effectively prevented.

Thus, a stable capacitance can be secured and the breakdown voltage can be increased by forming the inner electrodes with a high connectivity.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
an effective layer formed by alternately laminating inner electrodes and dielectric layers; and
a protection layer formed by stacking dielectric layers on upper and lower surfaces of the effective layer,
wherein the thickness of the protection layer is 10.0 to 30.0 times the sum of an average thickness of the inner electrodes and an average thickness of the dielectric layers within the effective layer.

2. The capacitor of claim 1, wherein the inner electrodes comprise:
a plurality of continuous intervals in which a conductive material is continuously formed; and
an interrupted interval filled with pores or ceramic between the neighboring continuous intervals,
wherein when the total length of the inner electrodes is A and the sum of the lengths of the continuous intervals is B, the following conditional expression 1 is satisfied:
0.92≦B/A<1. [Conditional expression 1]

3. The capacitor of claim 1, wherein the thickness of each of the dielectric layers within the effective layer is 5 um or less.

4. The capacitor of claim 2, wherein the thickness of each of the dielectric layers within the effective layer is 5 um or less.

5. The capacitor of claim 1, wherein the number of stacked dielectric layers within the effective layer is 100 or greater.

6. The capacitor of claim 2, wherein the number of stacked dielectric layers within the effective layer is 100 or greater.
